(19) United States
(12) Patent Application Publication
(10) Pub. No.: US 2017/0187885 A1
(43) Pub. Date: Jun. 29, 2017

(54) METHOD AND DEVICE FOR FREQUENCY SCANNING

(71) Applicants: AMBIT MICROSYSTEMS (SHANGHAI) LTD., Shanghai (CN); HON HAI PRECISION INDUSTRY CO., LTD., New Taipei (TW)

(72) Inventors: HAU-LUNG HUANG, New Taipei (TW); FAN-HUI LI, Shenzhen (CN)

(21) Appl. No.: 15/011,889

(22) Filed: Feb. 1, 2016

(30) Foreign Application Priority Data
Dec. 28, 2015 (CN) 201510995376.5

(51) Int. Cl. H04M 11/06

(52) U.S. Cl. CPC H04M 11/062

(57) ABSTRACT

A device set in a multimedia cable network includes a first modem including a first module to receive a beacon. The first modem has a first frequency and the beacon has a second frequency. When the first frequency of the first modem is not available, the first modem checks whether the second frequency is available in the multimedia cable network.

### FIELD

The subject matter herein generally relates to a device for frequency scanning and a method thereof.

### BACKGROUND

When a modem joins a new multimedia cable network, the modem will scan to get a using frequency of the new multimedia cable network.

### BRIEF DESCRIPTION OF THE DRAWINGS

Implementations of the present technology will now be described, by way of example only, with reference to the attached figures.

FIG. 1 is a block diagram of an embodiment of a device for frequency scanning of the present disclosure.

FIG. 2 is a block diagram of another embodiment of a device for frequency scanning of the present disclosure.

FIG. 3 is a flow chart of an embodiment of a method for frequency scanning of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently coupled or releasably coupled. The term “comprising,” when utilized, means “including, but not necessarily limited to”; it specifically indicates open-ended inclusion or membership in the so-described combination, group, series and the like. The term “operate normally”, means “operate without any issue”.

The disclosure will now be described in relation to a device in a multimedia cable network.

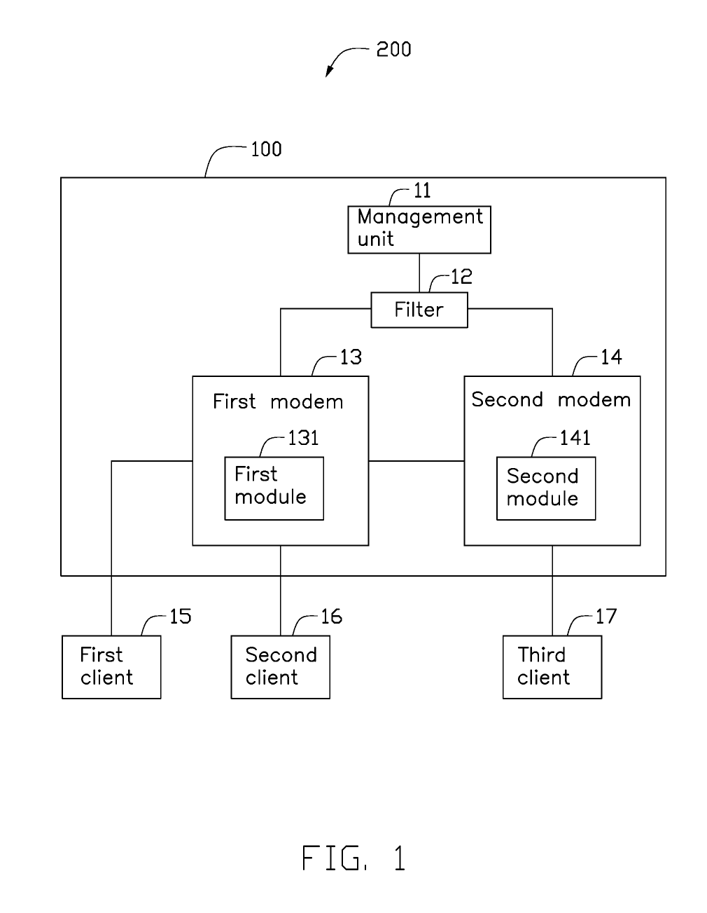

FIG. 1 illustrates a multimedia cable network 200. The multimedia cable network 200 can comprise a device 100, a first client 15, a second client 16, and a third client 17. The device 100 can comprise a management unit 11, a filter 12, a first modem 13, and a second modem 14.

The management unit 11 is coupled to the first modem 13 and the second modem 14 through the filter 12. The first modem 13 is coupled to the second modem 14. The first modem 13 is coupled to the first client 15 and the second client 16. The second modem 14 is coupled to the third client 17.

In an embodiment, the management unit 11 is configured to control the first modem 13 and the second modem 14. The management unit 11 can be used to set some parameters of the multimedia cable network 200. The parameters can comprise a downlink frequency and/or a descending level.

The filter 12 is configured to improve a quality of signals.

The first modem 13 can comprise a first module 131. The second modem 14 can comprise a second module 141.

A preset frequency can be defined in a manufacturing process of a modem. The preset frequency can also be a last frequency the modem used. In an embodiment, the second modem 14 has a first frequency used last time. The first module 131 and the second module 141 are configured to transmit beacons comprising a second frequency in use of the multimedia cable network 200.

In an embodiment, when the second modem 14 joins the multimedia cable network 200, the second modem 14 checks whether the first frequency is available. When the first frequency is available, the second modem 14 starts to operate. When the first frequency is not available, the second module 141 receives a beacon comprising the second frequency from the first module 131 and the second modem 14 checks whether the second frequency is available. When the second frequency is available, the second modem 14 starts to operate. When the second frequency is not available, the second modem 14 starts to scan a frequency of the multimedia cable network 200.

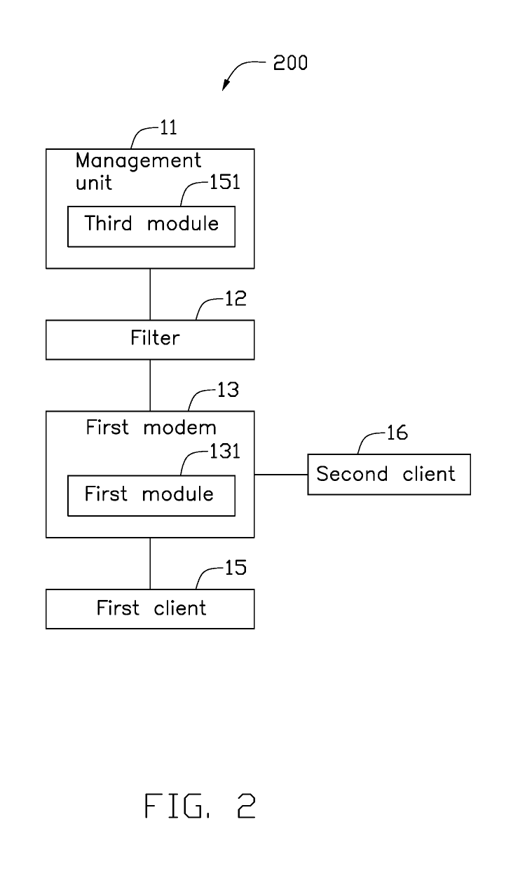

FIG. 2 illustrates another embodiment of a multimedia cable network 200. The multimedia cable network 200 can comprise the management unit 11, the filter 12, the first modem 13, the first client 15, and the second client 16.

The management unit 11 can comprise a third module 151. The third module 151 is configured to transmit a beacon which comprises the second frequency. The first modem has the first frequency which has been used last time. When the first modem 13 joins the multimedia cable network 200, the first modem 13 checks whether the first frequency is available. When the first frequency is available, the first modem 13 starts to operate. When the first frequency is not available, the first module 131 receives a beacon comprising the second frequency from the third module 151 and the first modem 13 checks whether the second frequency is available. When the second frequency is available, the first modem 13 starts to operate. When the second frequency is not available, the first modem 13 starts to scan a frequency of the multimedia cable network 200.

In at least one embodiment, the first client 15 can be but not limit to televisions and monitors.

In at least one embodiment, the first module 131, the second module 141, and the third module 151 can be chips of the multimedia of the coaxial cable alliance (MoCA).

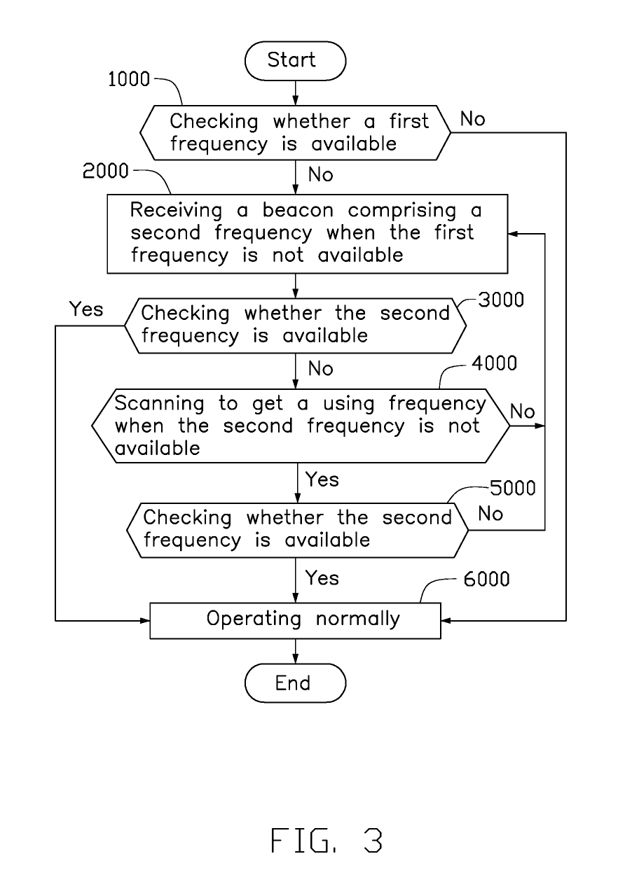

FIG. 3 illustrates a flowchart of a method to scan frequency. The example method is provided by way of example, as there are a variety of ways to carry out the method. The method described below can be carried out using the configurations illustrated in FIGS. 1-2, for example, and various elements of these figures are referenced in explaining the example method. Each block shown in FIG. 3 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure. The example method can begin at block 1000.

At block 1000, the first modem 13 checks whether the first frequency is available. When the first frequency is available, the method proceeds to block 6000. When the first frequency is not available, the method proceeds to block 2000.

At block 2000, the first modem 13 receives a beacon comprising the second frequency.

At block 3000, the first modem 13 checks whether the second frequency is available. When the second frequency is available, the method proceeds to block 6000. When the second frequency is not available, the method proceeds to block 4000.

At block 4000, the first modem 13 scans a frequency of the multimedia cable network 200. When the first modem 13 gets the frequency of the multimedia cable network, the method proceeds to block 6000. When the first modem 13 does not get the frequency of the multimedia cable network, the method proceeds to block 2000.

At block 5000, the first modem 13 checks whether the using frequency is available. When the second frequency is available, the method proceeds to block 6000. When the using frequency is not available, the method proceeds to block 2000.

At block 6000, the first modem 13 operates normally.

While the disclosure has been described by way of example and in terms of the embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A device set in a multimedia cable network comprising:
a first modem having a first frequency comprising a first module configured to receive a beacon having a second frequency, when the first frequency of the first modem is not available, the first modem checks whether the second frequency is available in the multimedia cable network.

2. The device as claim 1, further comprising a second modem, wherein the second modem comprises a second module to receive the beacon, when the second modem joins the multimedia cable network, the second module receives the beacon.

3. The device as claim 2, wherein the second module receives the beacon from the first module of the first modem.

4. The device as claim 1, further comprising a management unit coupled to the first modem, wherein the management unit is configured to control the first modem.

5. The device as claim 4, wherein the management unit is configured to set parameters of the multimedia cable network.

6. The device as claim 5, wherein the parameters of the multimedia cable network comprise a downlink frequency.

7. The device as claim 4, wherein the management unit comprise a third module to output the beacon.

8. The device as claim 4, further comprising a filter coupled between the management unit and the first modem.

9. The device as claim 1, wherein when the second frequency is not available, the first modem starts to scan a frequency of the multimedia cable network.

10. A method for frequency scanning, comprising:
determining whether a first frequency is available;
receiving a beacon comprising a second frequency when the first frequency is not available;
determining whether the second frequency is available; and
scanning to get a using frequency when the second frequency is not available.

11. The method as claim 10, further comprising determining the using frequency is available.
